(19) United States
(12) Patent Application Publication
(10) Pub. No.: US 2015/0125105 A1
(43) Pub. Date: May 7, 2015

(54) METHOD OF FORMING A DRAWN CUP WITH UNDERCUTS

(71) Applicant: SCHAEFFLER TECHNOLOGIES GMBH & CO. KG, Herzogenaurach (DE)

(72) Inventor: Seth Claus, Charlotte, NC (US)

(73) Assignee: SCHAEFFLER TECHNOLOGIES GMBH & CO. KG, Herzogenaurach (DE)

(21) Appl. No.: 14/528,470

(22) Filed: Oct. 30, 2014

Related U.S. Application Data
(60) Provisional application No. 61/898,527, filed on Nov. 1, 2013.

(51) Int. Cl. F16C 33/64; B23P 15/00

(52) U.S. Cl. CPC F16C 33/64; B23P 15/003
USPC 384/569; 29/898.06

(57) ABSTRACT

A method for manufacturing a bearing ring is provided. The method includes punching out a blank from sheet metal. A radially extending groove is formed in the blank. The blank is stamped in a cup-shaped die which creates an axially extending side wall and a bottom wall, with a first undercut being formed by the radially extending groove located at a juncture between the side wall and the bottom wall at a first axial end portion of the bearing ring. A second axial end portion of the side wall is thinned. The second axial end portion is then bent creating a flange with a second undercut located at a juncture between the flange and the side wall.

### INCORPORATION BY REFERENCE

The following documents are incorporated herein by reference as if fully set forth: U.S. Provisional Patent Application No. 61/898,527, filed Nov. 1, 2013.

### FIELD OF INVENTION

This invention is generally related to a bearing ring and more particularly to a method of forming the bearing ring.

### BACKGROUND

Known solutions for forming bearing rings from sheet metal lack clearance for ends of rollers. Typically, post-formation tooling is required to create undercuts in the bearing rings to provide clearance for the ends of the rollers.

### SUMMARY

It would be desirable to provide a simple method for forming undercuts in a bearing ring without post-formation tooling.

A method for manufacturing a bearing ring is provided. The method includes punching out a blank from sheet metal. A radially extending groove is formed in the blank. The blank is stamped in a cup-shaped die which creates an axially extending side wall and a bottom wall, with a first undercut formed by the radially extending groove located at a juncture between the side wall and the bottom wall at a first axial end portion of the bearing ring. A second axial end portion of the side wall is thinned. The second axial end portion is then bent creating a flange with a second undercut located at a juncture between the flange and the side wall.

Preferred arrangements with one or more features of the invention are described below and in the claims.

### BRIEF DESCRIPTION OF THE DRAWINGS

The foregoing Summary as well as the following Detailed Description will be best understood when read in conjunction with the appended drawings. In the drawings:

FIG. 1A is a perspective view of a blank after being punched.

FIG. 1B is a top planar view of the blank after being punched.

FIG. 2A is a perspective view of the blank after a radially extending groove is formed.

FIG. 2B is a top planar view of the blank after the radially extending groove is formed.

FIG. 2C is a cross-sectional view through the blank taken along line 2C-2C in FIG. 2B.

FIG. 3 is a perspective cutaway view of the blank after stamping in a cup-shaped die.

FIG. 4 is a perspective cutaway view of the blank after an axial end portion of a side wall is thinned.

FIG. 5 is a perspective cutaway view of the blank after punching an opening at a bottom wall.

FIG. 6 is a perspective cutaway view of the blank after bending over the axial end portion of the sidewall.

FIG. 7 is an enlarged view of a rolling bearing assembly with a radially outer bearing ring including undercuts at junctures between the sidewall and flanges.

### DETAILED DESCRIPTION OF THE PREFERRED EMBODIMENTS

Certain terminology is used in the following description for convenience only and is not limiting. The words “inner,” “outer,” “inwardly,” and “outwardly” refer to directions towards and away from the parts referenced in the drawings. A reference to a list of items that are cited as “at least one of a, b, or c” (where a, b, and c represent the items being listed) means any single one of the items a, b, c or combinations thereof. The terminology includes the words specifically noted above, derivates thereof, and words of similar import.

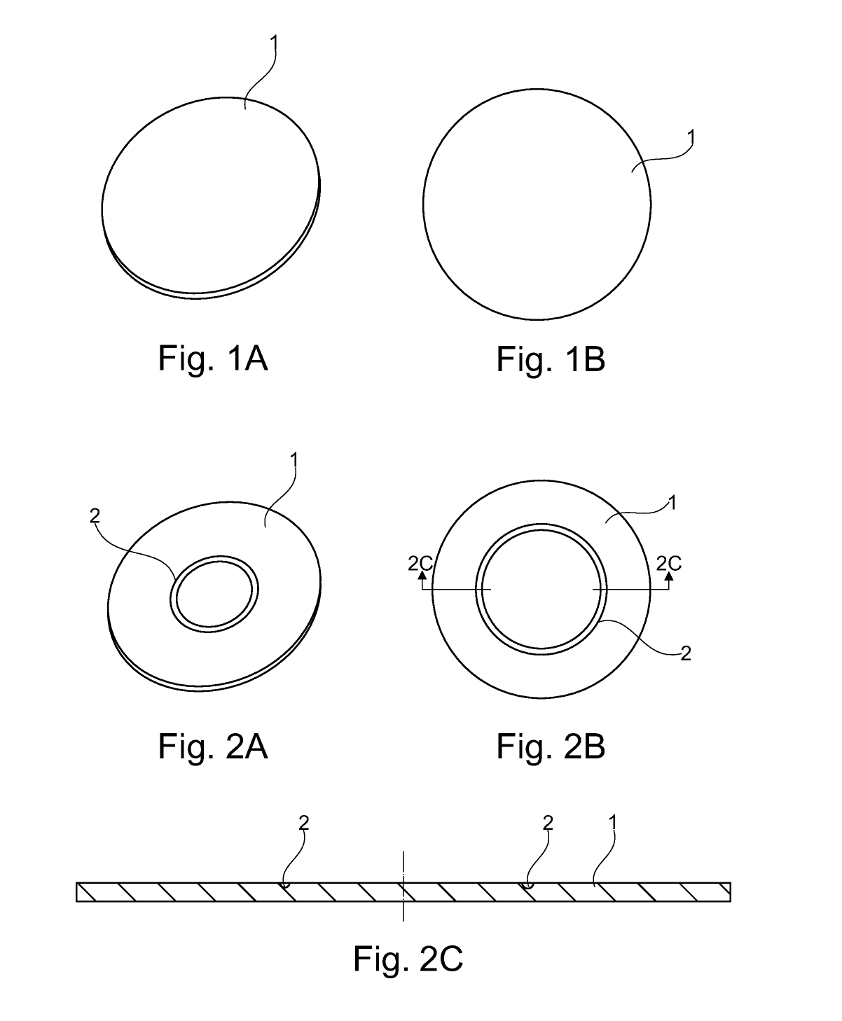

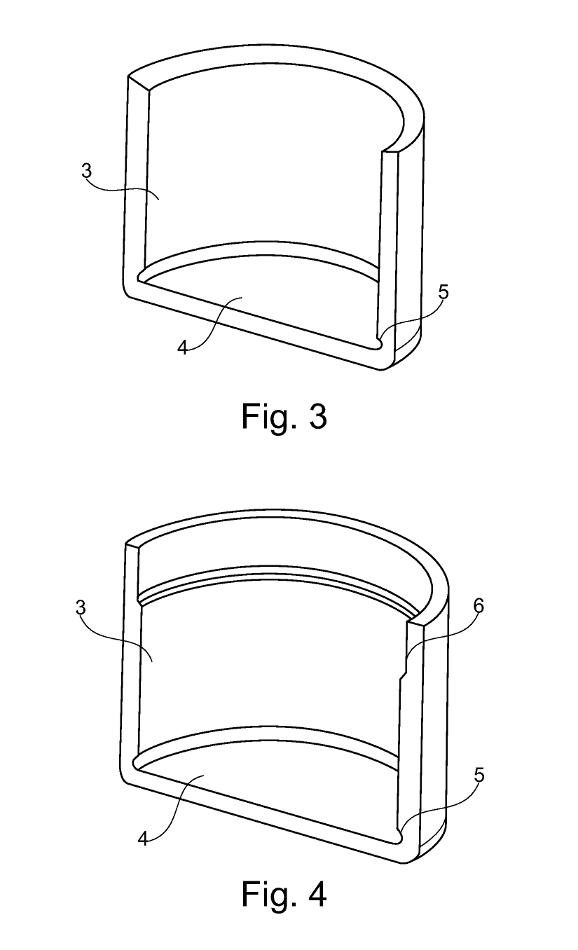

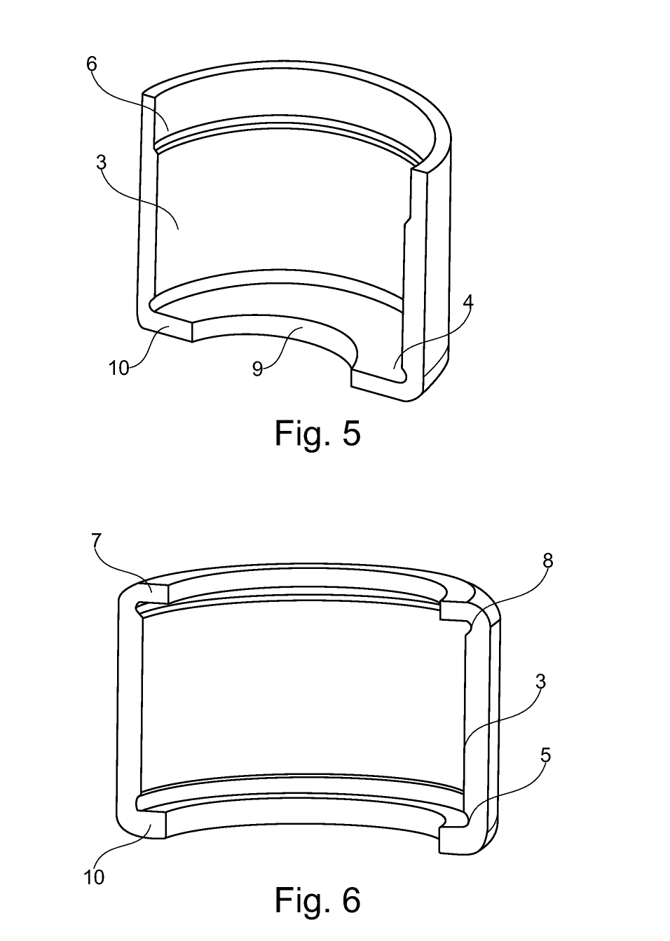

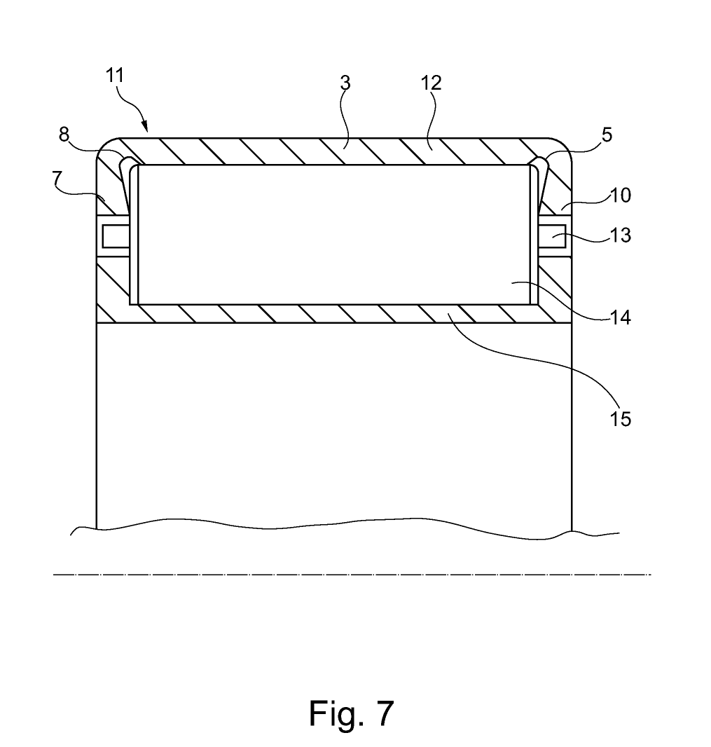

A method for manufacturing a bearing ring is provided. The bearing ring is preferably formed from low carbon steel. As shown in FIGS. 1A and 1B, the method includes punching out a blank 1 from sheet metal. The blank 1 is preferably circular after punching. As shown in FIGS. 2A-2C, a radially extending groove 2 is formed in the blank 1. The radially extending groove 2 is preferably formed via a die. As shown in FIG. 3, the blank 1 is then stamped in a cup-shaped die which creates an axially extending side wall 3 and a bottom wall 4, with a first undercut 5 formed by the radially extending groove 2 located at a juncture between the side wall 3 and the bottom wall 4 at a first axial end portion of the bearing ring. As shown in FIG. 4, a second axial end portion 6 of the side wall 3 is thinned. As shown in FIG. 5, the method preferably includes punching an opening 9 at the bottom wall 4 and creating a flange 10 at the first axial end portion. As shown in FIG. 6, the second axial end portion 6 is then bent which creates a flange 7 with a second undercut 8 located at a juncture between the flange 7 and the side wall 3. As shown in FIG. 7, the first and second undercuts 5, 8 provide clearance for ends of rollers to be supported on the bearing ring. The bearing ring is then heat treated and cleaned prior to assembly into a roller bearing. FIG. 7 shows the bearing ring as a radially outer bearing ring 12 in a rolling bearing assembly 11 including a cage 13 and a plurality of rolling elements 14. In one embodiment, the rolling bearing assembly 11 includes a radially inner bearing ring 15.

Having thus described various embodiments of the present methods of manufacturing a bearing ring in detail, it is to be appreciated and will be apparent to those skilled in the art that many changes, only a few of which are exemplified in the detailed description above, could be made in the methods without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

### LOG TO REFERENCE NUMBERS

1 Blank
2 Radially extending groove
3 Side wall
4 Bottom wall
5 First undercut
6 Second axial end portion
7 Flange at second axial end portion
8 Second undercut
9 Opening
10 Flange at first axial end portion
11 Rolling bearing assembly
12 Radially outer bearing ring
13 Cage
14 Rolling elements
15 Radially inner bearing ring

What is claimed is:

1. A method for manufacturing a bearing ring, comprising:
punching out a blank from sheet metal;
forming a radially extending groove in the blank;
stamping the blank in a cup-shaped die and creating an axially extending side wall and a bottom wall, with a first undercut formed by the radially extending groove located at a juncture between the side wall and the bottom wall at a first axial end portion of the bearing ring;
thinning a second axial end portion of the side wall; and
bending the second axial end portion and creating a flange with a second undercut located at a juncture between the flange and the side wall.

2. The method of claim 1, wherein the blank is circular after punching.

3. The method of claim 1, further comprising punching an opening through the bottom wall and creating a flange at the first axial end portion of the bearing ring.

4. The method of claim 1, wherein the radially extending groove is formed via a die.

5. The method of claim 1, wherein the blank is formed from low carbon steel.

6. The method of claim 1, further comprising hardening the bearing ring.

7. The method of claim 1, further comprising heat treating the bearing ring.

8. A rolling bearing assembly comprising:
a radially outer bearing ring formed by punching out a blank from sheet metal, forming a radially extending groove in the blank, stamping the blank in a cup-shaped die and creating an axially extending side wall and a bottom wall, with a first undercut formed by the radially extending groove located at a juncture between the side wall and the bottom wall at a first axial end portion of the bearing ring, thinning a second axial end portion of the side wall, and bending the second axial end portion and creating a flange with a second undercut located at a juncture between the flange and the side wall, and
a plurality of rolling elements supported to roll on at least the side wall of the radially outer bearing outer ring.

9. The rolling bearing assembly of claim 8, further comprising a radially inner bearing ring.
